(19) United States
(12) Patent Application Publication
(10) Pub. No.: US 2006/0136379 A1
(43) Pub. Date: Jun. 22, 2006

(54) Image content sharing device and method

(75) Inventors: Frank Marino, Rochester, NY (US); Michael J. Telek, Pittsford, NY (US); Carolyn A. Zacks, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/015,905

(22) Filed: Dec. 17, 2004

(51) Int. Cl. G06F 17/30

(52) U.S. Cl. 707/3

(57) ABSTRACT

Image content sharing devices and methods are provided. The image content sharing device has a display, a memory, a user input capable of receiving more than one user input action and of providing a user input signal indicative of each of the more than one user input actions and a controller. The controller is operable in an image content presentation mode, wherein the controller causes image content to be presented on the display and at least one other mode; with the controller being adapted so that when the controller is in the image content presentation mode and detects a user input signal, the controller determines at least one destination based upon the user input signal detected and arranges for the presented image content to be automatically transmitted to the at least one destination, with the controller further being operable in at least one other mode.

### FIELD OF THE INVENTION

The invention relates generally to the field of digital imaging, and in particular to the transmission of digital images and other content.

### BACKGROUND OF THE INVENTION

Various methods are available to share digital images between two parties. One known method is to attach a digital file comprising a digital image as part of an electronic message, for example, e-mail. When the recipient receives the electronic message, the digital file can be detached and the image viewed. Another known method employs on-line service providers, for example Ofoto, Inc. On-line service providers support websites/databases, which permit a user to store/access/share digital images between two or more parties. For example, using a website, a user can arrange a collection of images which can be viewed by individuals authorized by the user. These authorized individuals can view the collection of images and can order prints of the images. While such systems may have achieved certain degrees of success in their particular applications, some systems have disadvantages.

For example, some systems require the use of a computer, and therefore, the user needs to be computer literate to send/receive an image. Even where a user is proficient with computer, such systems typically require user to execute a number of steps in order to successfully transfer an image to a recipient. First, a connection must be established between the device having the content and the computer. Second, a connection must be established between the computer and the remote image server. Third, a user typically must provide some form of identification and authentication to access the site so that digital images or other data can be transferred to the site. Fourth, a user must then identify each image that is to be transferred from a server to the remote destination. Fifth, the user must identify the remote destination and sixth, the user typically must provide some form of confirmation that the user does indeed wish to provide the digital image or other content to the remote destination. It will be appreciated that with each additional step required in this process, users become increasingly less likely to share images in this fashion.

Accordingly, systems have been developed that have made image content sharing easier. For example, the Kodak EASYSHARE digital cameras sold by the Eastman Kodak Company a designated share button. When a user of the camera determines that the user wishes to share digital image content stored therein by sending the image content to a remote address, the user presses the share button and this causes a list of addresses that is preprogrammed into the camera to appear. The user selects from among the addresses in the list, destinations to which the selected image is to be sent. When the camera is next connected to a personal computer, EASYSHARE image management software on the computer causes such images to be automatically transmitted to each of the selected addresses. The system is exceptionally popular with consumers and has proven commercial value.

Recently, cellular telephones that incorporate digital cameras, or other devices that are otherwise are capable of sharing image content have become increasingly popular. Such cellular telephones allow users to share images or other content by way of establishing a communication link between cellular telephones using conventional dialing or speed dialing capabilities and then transferring the digital images or other content by way of the connection. Such cellular telephone based systems also typically allow a user to indicate that a particular image is to be sent to a particular e-mail address that has been prerecorded in the cellular telephone.

It will be appreciated that such methods require a user of such a digital camera or cell phone to take a number of steps to transmit digital image content. What is desired is a further reduction in the number of steps to the user must take to cause a device to transmit digital image content to a remote destination.

U.S. Patent Application Publication No. 2003 [symbol] 0184793, entitled “Method and Apparatus for Uploading Content from a Device to a Remote Network Location” filed by Pineau on Mar. 14, 2002, describes techniques for uploading content (such as a digital photograph) from a content upload device to the content server over a communication network and for automatically forwarding the content from the content server to one or more remote destinations. A user of the content output device may cause the content upload device to upload the content to the server by initiating a single action, such as pressing a single button on the content upload device and without providing information identifying the user to the content upload device. Upon receiving the content, the content server may add content to a queue, referred to as a content outbox, associated with the user. The content server may automatically forward the content in the user's content outbox to one or more remote destinations specified by preferences associated with the user's content outbox. It will be appreciated however, that while the content is transferred with the depression of a single button, the determination of how, where and with whom the content is transmitted is made automatically based upon the profile. There is no opportunity for a user to change the distribution pattern defined by the profile for a particular image. Thus such an approach does not provide a flexible solution that provides for convenient decision making for individual images.

Accordingly, a need exists for an image content sharing device and method of sharing images between at least two parties, which can be used with a computer but does not require, the use of a computer to send/receive images and which is adapted to facilitate the process of designating how an image is to be shared with remote users.

A further need exists in the art for image sharing devices that provide such increased functionality while maintaining a small size, for example, many cellular telephones and digital cameras, portable image sharing devices and the like identify the relatively small size of the device as a convenience and lifestyle advantage. Thus, what is also needed in the art is an image content sharing device that enables rapid and easy sharing of image content but that does not increase the size, cost or complexity of an image sharing device.

### SUMMARY OF THE INVENTION

In one aspect of the invention, an image content sharing device is provided. The image content sharing device has a display, a memory, a user input capable of receiving more than one user input action and of providing a user input signal indicative of each of the more than one user input actions and a controller. The controller is operable in an image content presentation mode, wherein the controller causes image content to be presented on the display and at least one other mode with the controller being adapted so that when the controller is in the image content presentation mode and detects a user input signal, the controller determines at least one destination from among more than one possible destination based upon the user input signal detected and arranges for the presented image content to be automatically transmitted to the at least one destination, with the controller further being operable in at least one other mode, so that when the controller is in the at least one other mode and the controller detects the same user input signal, the controller responds thereto in a manner that is different from the manner in which the controller responds to the user input signal when the controller is in the image content presentation mode.

In another aspect of the invention, an image content sharing device is provided. The image content sharing device comprises a display, a user input circuit having a plurality of inputs adapted to provide differentiable input signals with each differentiable input signal being generated in response to a different user input action and a controller. The controller is operable to receive the set of differentiable input signals and to use the sensed input signals to perform a set of operations, including causing image content to be presented on the display. The controller is further operable during presentation of the image content, to sense at least a portion of the same set of differentiable input signals and to arrange for the image content to be transmitted to a particular destination selected from among more than one possible destination based upon the sensed differentiable input signals.

In still another aspect of the invention, a method for operating an image content sharing device is provided. In accordance with the method, image content is presented and at least one user input action during presentation of the image content is detected. A destination, from among more than one possible destination, is determined for sharing the presented image content based upon the user input action detected during the display of the digital image content and it is arranged for the presented image content to be transmitted to the determined destination without further user input action.

### BRIEF DESCRIPTION OF THE DRAWINGS

FIG. 1 shows a block diagram of one embodiment of an image content sharing device of the invention;

FIG. 2 shows an exterior view of the image content sharing device of FIG. 1 and a view of a scene;

FIG. 3 shows a flow chart depicting a sequence of steps for transmitting image content using the image content sharing device of FIG. 1;

FIGS. 4A-4C illustrate the transmission of digital image content in accordance with the method of FIG. 3;

FIG. 5 illustrates one embodiment of a data structure that can be used by a controller of the digital image content sharing device in determining a destination for the digital image content based upon a user action;

FIG. 6 illustrates the use of an intermediary in the transfer of digital image content;

FIGS. 7A illustrates another embodiment of data structure that can be used by a controller of the image content sharing device to arrange for digital image content to be transferred to selected destinations;

FIG. 7B illustrates a data structure that can be used by an intermediate device to use data arranged by the controller of the image content sharing device to cause the digital image content to be sent to selected destinations; and

FIGS. 8A, 8B and 8C illustrate the use of one embodiment of an image sharing device having optional graphic indications of a confirmation of the transmission of an image and optional destination indications provided in association with the user input system.

### DETAILED DESCRIPTION OF THE INVENTION

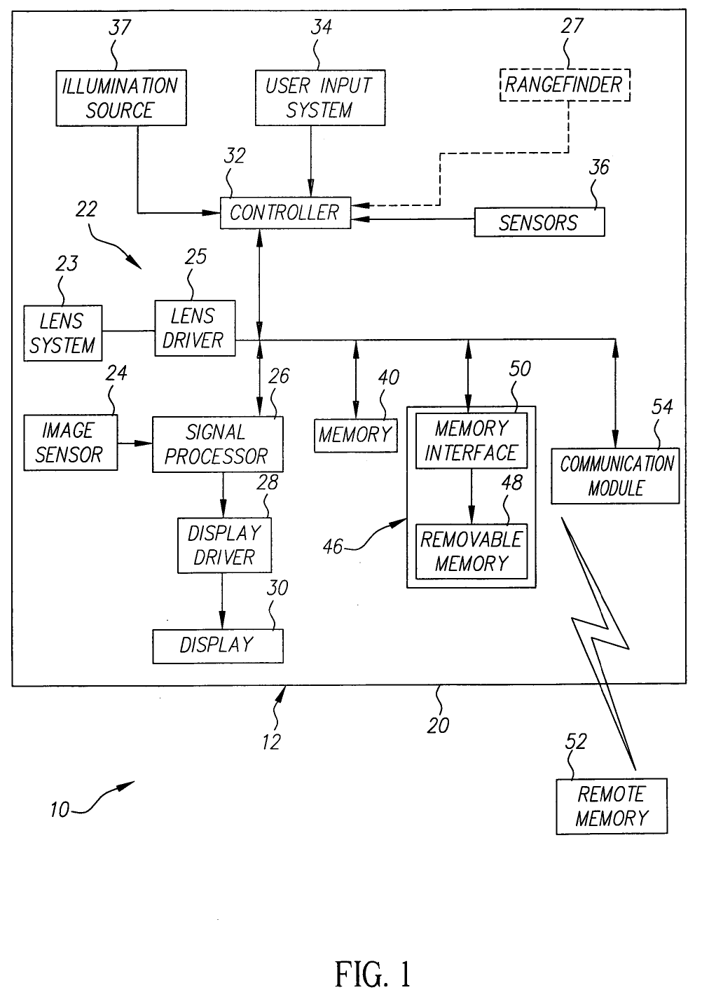

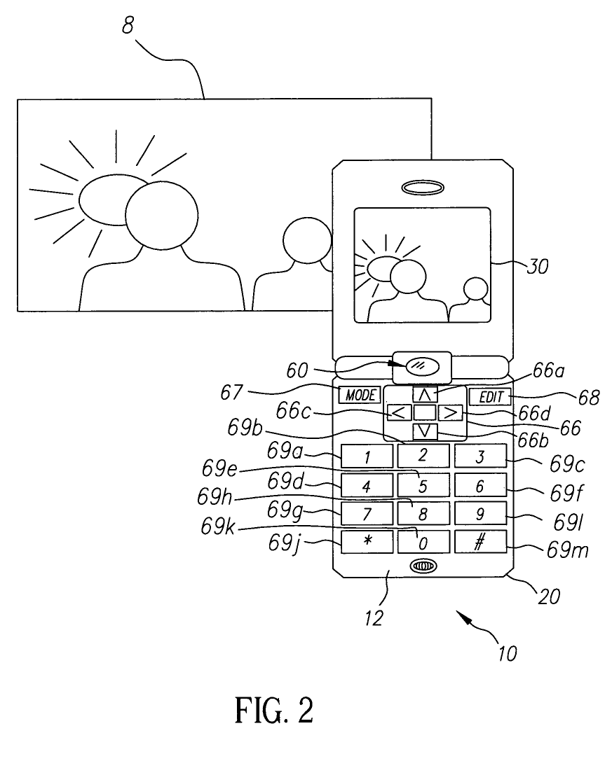

FIG. 1 shows a block diagram of an embodiment of an image content sharing device 10. FIG. 2 shows a scene and a back, elevation view of the image content sharing device 10 of FIG. 1. As is shown in FIGS. 1 and 2, image content sharing device 10 takes the form of a digital camera/cell phone combination 12 comprising a body 20 containing a scene image capture system 22 having a scene lens system 23, a image sensor 24, a signal processor 26, an optional display driver 28 and a display 30. In operation, light from a scene 8 is focused by scene lens system 23 to form an image on image sensor 24.

Scene lens system 23 can have one or more elements and can be of a fixed focus type or can be manually or automatically adjustable. In the example embodiment shown in FIG. 1, lens system 23 is shown as having an automatic adjustable system having a 6× zoom lens unit in which a mobile element or elements (not shown) are driven, relative to a stationary element or elements (not shown) by a motorized lens driver 25. Lens driver 25 controls both the lens focal length and the lens focus position of scene lens system 23 and sets a lens focal length and/or position based upon signals from signal processor 26, an optional automatic range finder system 27, and/or controller 32. A feedback loop is established between lens driver 25, signal processor 26, range finder 27 and/or controller 32 so that the focus position of scene lens system 23 can be rapidly set. Settings can be determined manually by way of user input system 34 or can be determined automatically based upon optional range finder system 27 or based upon other common focus determining arrangements such as the so-called “through focusing” or whole way focusing techniques or other techniques known to those of skill in the art.

Scene lens system 23 can provide a fixed zoom or a variable zoom capability. In the embodiment shown, lens driver 25 is further adapted to provide such a zoom magnification by adjusting the position of one or more mobile elements (not shown) relative to one or more stationary elements (not shown) of scene lens system 23 based upon signals from signal processor 26, an automatic range finder system 27, and/or controller 32. Controller 32 can determine a zoom setting based upon manual inputs made using user input system 34 or in other ways. Scene lens system 23 can employ other known arrangements for providing an adjustable zoom, including for example a manual adjustment system.

Light from the scene 8 that is focused by scene lens system 23 onto scene image sensor 24 is converted into image signals representing an image of the scene. Scene image sensor 24 can comprise a charge couple device (CCD), a complimentary metal oxide sensor (CMOS), or any other electronic image sensor known to those of ordinary skill in the art. The image signals can be in digital or analog form.

Signal processor 26 receives image signals from scene image sensor 24 and transforms the image signals into image content in the form of digital data. As used herein the image content includes, without limitation, any form of digital data that can be used to represent a still image, a sequence of still images, combinations of still images, video segments and sequences such as any form of image, portions of images or combinations of images that can be reconstituted into a human perceptible form and perceived as providing motion images including but not limited to digital image content, including but not limited to image sequences and image streams. Where the digital image data comprises a stream of apparently moving images, the digital image data can comprise image data stored in an interleaved or interlaced image form, a sequence of still images, and/or other forms known to those of skill in the art of digital video.

Signal processor 26 can apply various image processing algorithms to the image signals when forming image content. These can include but are not limited to color and exposure balancing, interpolation and compression. Where the image signals are in the form of analog signals, signal processor 26 also converts these analog signals into a digital form. In certain embodiments of the invention, signal processor 26 can be adapted to process the image signal so that the image content formed thereby appears to have been captured at a different zoom setting than that actually provided by the optical lens system. This can be done by using a subset of the image signals from scene image sensor 24 and interpolating the subset of the image signals to form the digital image. This is known generally in the art as “digital zoom”. Such digital zoom can be used to provide electronically controllable zoom adjusted in fixed focus, manual focus, and even automatically adjustable focus systems.

Controller 32 controls the operation of the image content sharing device 10 including, but not limited to, a scene image capture system 22, display 30 and memory such as memory 40. Controller 32 can comprise a microprocessor such as a programmable general purpose microprocessor, a dedicated micro-processor or micro-controller, a combination of discrete components or any other system that can be used to control operation of image content sharing device 10. During operation, controller 32 causes image sensor 24, signal processor 26, display 30 and memory 40 to capture, present, store and/or transmit digital image content in response to signals received from a user input system 34, from signal processor 26 and from optional sensors 36.

Controller 32 cooperates with a user input system 34 to allow image content sharing device 10 to interact with a user. User input system 34 can comprise any form of transducer, switch, sensor or other device capable of receiving or sensing an input action of a user and converting this input action into a user input signal that can be used by controller 32 in operating image content sharing device 10. For example, user input system 34 can comprise a touch screen input, a touch pad input, a 4-way switch, a 6-way switch, an 8-way switch, a stylus system, a trackball system, a joystick system, a voice recognition system, a gesture recognition system or other such systems.

In the digital camera/cellular phone 12 embodiment of image content sharing device 10 shown in FIGS. 1 and 2, user input system 34 includes a capture button 60 that sends a trigger signal to controller 32 indicating a desire to capture an image. User input system 34 can also includes keys such as directional keypad 66. In this embodiment, keypad 66 is shown as comprising four directional arrow keys, an up arrow key 66a, a down arrow key 66b, a left arrow key 66c and a right arrow key 66d. A mode select button 67, and an edit button 68 are also provided as shown in FIG. 2. As is also shown in FIG. 2, a keypad 69 is provided having numeric keys shown as one key 69a, two key 69b, three key 69c, four key 69d, five key 69e, six key 69f, seven key 69g, eight key 69h, nine key 69i, an star key 69j, a zero key 69k, and a pound key 69k.

It will be appreciated that the user input signal provided by user input system 34 comprises one or more signals from which controller 32 can determine what user input actions a user of image content sharing device 10 is taking at any given moment. In this regard, each transducer or other device that is capable of receiving or sensing a user input action causes user input system 34 to generate an input signal that is differentiable in that controller 32 can use the input signal to determine which what transducer or other device has been actuated by a user and/or how that device has been actuated, or what has been sensed.

Sensors 36 are optional and can include light sensors and other sensors known in the art that can be used to detect conditions in the environment surrounding image content sharing device 10 and to convert this information into a form that can be used by controller 32 in governing operation of image content sharing device 10. Sensors 36 can include audio sensors adapted to capture sounds. Such audio sensors can be of conventional design or can be capable of providing controllably focused audio capture such as the audio zoom system described in U.S. Pat. No. 4,862,278, entitled “Video Camera Microphone with Zoom Variable Acoustic Focus”, filed by Dann et al. on Oct. 14, 1986. Sensors 36 can also include biometric sensors adapted to detect characteristics of a user for security and affective imaging purposes. Where a need for illumination is determined, controller 32 can cause a source of artificial illumination 37 such as a light, strobe, or flash system to emit light.

Controller 32 generates capture signal that causes digital image content to be captured when a trigger condition is detected. Typically, the controller 32 receives a trigger signal from capture button 60. When the trigger condition occurs when a user depresses capture button 60, however, controller 32 can determine that a trigger condition exists at a particular time, or at a particular time after capture button 60 is depressed. Alternatively, controller 32 can determine that a trigger condition exists when optional sensors 36 detect certain environmental conditions, such as optical or radio frequency signals. Further controller 32 can determine that a trigger condition exists based upon affective signals obtained from the physiology of a user.

Controller 32 can also be used to generate metadata in association with the digital image content. Metadata is data that is related to digital image content or to a portion of such digital image content but that is not necessarily observable in the image content itself. In this regard, controller 32 can receive signals from signal processor 26, camera user input system 34 and other sensors 36 and can generate optional metadata based upon such signals. The metadata can include but is not limited to information such as the time, date and location that the digital image content was captured or otherwise formed, the type of image sensor 24, mode setting information, integration time information, lens system 23 setting information that characterizes the process used to capture or create the digital image content and processes, methods and algorithms used by image content sharing device 10 to form the scene image. The metadata can also include but is not limited to any other information determined by controller 32 or stored in any memory in image content sharing device 10 such as information that identifies image content sharing device 10, and/or instructions for rendering or otherwise processing the digital image with which the metadata is associated. The metadata can also comprise an instruction to incorporate a particular message into digital image content when presented. Such a message can be a text message to be rendered when the digital image content is presented or rendered. The metadata can also include audio signals. The metadata can further include digital image data. In one embodiment of the invention, where digital zoom is used to form the image content from a subset of one or more captured images, the metadata can include image data from portions of an image that are not incorporated into the subset of the digital image that is used to form the digital image. The metadata can also include any other information entered into image content sharing device 10.

The digital image content and optional metadata, can be stored in a compressed form. For example where the digital image content comprises a sequence of still images, the still images can be stored in a compressed form such as by using the JPEG (Joint Photographic Experts Group) ISO 10918-1 (ITU-T.81) standard. This JPEG compressed image data is stored using the so-called “Exif” image format defined in the Exchangeable Image File Format version 2.2 published by the Japan Electronics and Information Technology Industries Association JEITA CP-3451. Similarly, other compression systems such as the MPEG-4 (Motion Pictures Export Group) or Apple QuickTime™ standard can be used to store digital image content in a video form. Other image compression and storage forms can be used.

The digital image content and metadata can be stored in a memory such as memory 40. Memory 40 can include conventional memory devices including solid state, magnetic, optical or other data storage devices. Memory 40 can be fixed within image content sharing device 10 or it can be removable. In the embodiment of FIG. 1, image content sharing device 10 is shown having a memory card slot 46 that holds a removable memory 48 such as a removable memory card and has a memory interface 50 for communicating with removable memory 48. The digital images and metadata can also be stored in a remote memory system 52 that is external to image content sharing device 10 such as a personal computer, computer network or other imaging system.

In the embodiment shown in FIGS. 1 and 2, image content sharing device 10 has a communication circuit 54 for communicating with external devices such as, for example, remote memory system 52. The communication circuit 54 can have for example, an optical, radio frequency or other circuit or transducer that converts image and other data into a form, such as an optical signal, radio frequency signal or other form of signal, that can be conveyed to an external device by way of a wired or wireless connection.

Communication circuit 54 can be used to receive image content from external sources, including but not limited to a host computer (not shown), network (not shown), a separate digital image capture device or an image storage device. Such image content can be of a type that is captured using an external digital image capture system, or can be in whole or in part generated electronically, such as can be generated by digital image creation systems or digital image processing system. In this regard, it will be appreciated that while, in FIGS. 1 and 2 an embodiment of an image content sharing device 10 is shown having a scene image capture system 22, such an image capture system 22 is not necessary as certain embodiments of image content sharing device 10 obtain image content in this fashion.

For example, where communication circuit 54 is adapted to communicate by way of a cellular telephone network, communication circuit 54 can be associated with a cellular telephone number or other identifying number that for example another user of the cellular telephone network such as the user of a telephone equipped with a digital camera can use to establish a communication link with image content sharing device 10. In such an embodiment, controller 32 can cause communication circuit 54 to transmit signals causing an image to be captured by the separate image content sharing device 10 and can cause the separate image content sharing device 10 to transmit digital image content that can be received by communication circuit 54. In another alternative, image content in image content sharing device 10 can be conveyed to image content sharing device 10 when such images are captured by a separate image content sharing device and recorded on a removable memory 48 that is operatively associated with memory interface 50. Accordingly, there are a variety of ways in which image content sharing device 10 can obtain image content.

It will further be appreciated that, in certain embodiments, communication circuit 54 can provide other information to controller 32 such as a data that can be used for creating metadata and other information and instructions such as signals from a remote control device (not shown) such as a remote capture button (not shown) and can operate image content sharing device 10 in accordance with such signals.

Display 30 can comprise, for example, a color liquid crystal display (LCD), organic light emitting display (OLED) also known as an organic electro-luminescent display (OELD) or other type of video display. Display 30 can be external as is shown in FIG. 2, or it can be internal for example used in a viewfinder system 38. Alternatively, image content sharing device 10 can have more than one display 30 with, for example, one being external and one internal.

Signal processor 26 and/or controller 32 can also cooperate to generate other images such as text, graphics, icons and other information for presentation on display 30 that can allow interactive communication between controller 32 and a user of image content sharing device 10, with display 30 providing information to the user of image content sharing device 10 and the user of image content sharing device 10 using user input system 34 to interactively provide information to image content sharing device 10. Image content sharing device 10 can also have other displays such as a segmented LCD or LED display (not shown), which can also permit signal processor 26 and/or controller 32 to provide information to user. This capability is used for a variety of purposes such as establishing modes of operation, entering control settings, user preferences, and providing warnings and instructions to a user of image content sharing device 10.

Other systems such as known circuits, lights and actuators for generating visual signals, audio signals, vibrations, haptic feedback and/or other forms of human perceptible signals can also be incorporated into image content sharing device 10 for use in providing information, feedback and warnings to the user of image content sharing device 10.

Typically, display 30 has less imaging resolution than image sensor 24. Accordingly, in such embodiments, signal processor 26 and/or controller 32 are adapted to present the image content by forming evaluation content which has an appearance that corresponds to image content in image content sharing device 10 and is adapted for presentation on display 30. In one example of this type, signal processor 26 reduces the resolution of the image content captured by image capture system 22 when forming evaluation images adapted for presentation on display 30. Down sampling and other conventional techniques for reducing the overall imaging resolution can be used. For example, resampling techniques such as are described in commonly assigned U.S. Pat. No. 5,164,831, “Electronic Still Camera Providing Multi-Format Storage Of Full And Reduced Resolution Images” filed by Kuchta et al. on Mar. 15, 1990, can be used. The evaluation content can optionally be stored in a memory such as memory 40. The evaluation content can be adapted to be provided to an optional display driver 28 that can be used to drive display 30. Alternatively, the evaluation content can be converted into signals that can be transmitted by signal processor 26 in a form that directly causes display 30 to present the evaluation images. Where this is done, display driver 28 can be omitted.

In the embodiment shown in FIGS. 1 and 2, controller 32 enters the image composition process when capture button 60 is moved to a half-depression position. However, other methods for determining when to enter a composition process can be used. For example, edit button 68 shown in FIG. 2 can be depressed by a user of image content sharing device 10, and can be interpreted by controller 32 as an instruction to enter the composition process. The evaluation images presented during composition can help a user to compose the scene for the capture of a scene image.

As noted above the capture process is executed in response to controller 32 determining that a trigger condition exists. In the embodiment of FIGS. 1 and 2, a trigger signal is generated when capture button 60 is moved to a full depression condition and controller 32 determines that a trigger condition exists when controller 32 detects the trigger signal. During the capture process, controller 32 sends a capture signal causing signal processor 26 to obtain image signals from image sensor 24 and to process the image signals to form digital image data comprising an digital image content.

During capture and/or during an optional verification process, the image content or associated evaluation content is presented on display 30 so that users can verify that image content being captured or image content that has been captured has an acceptable appearance.

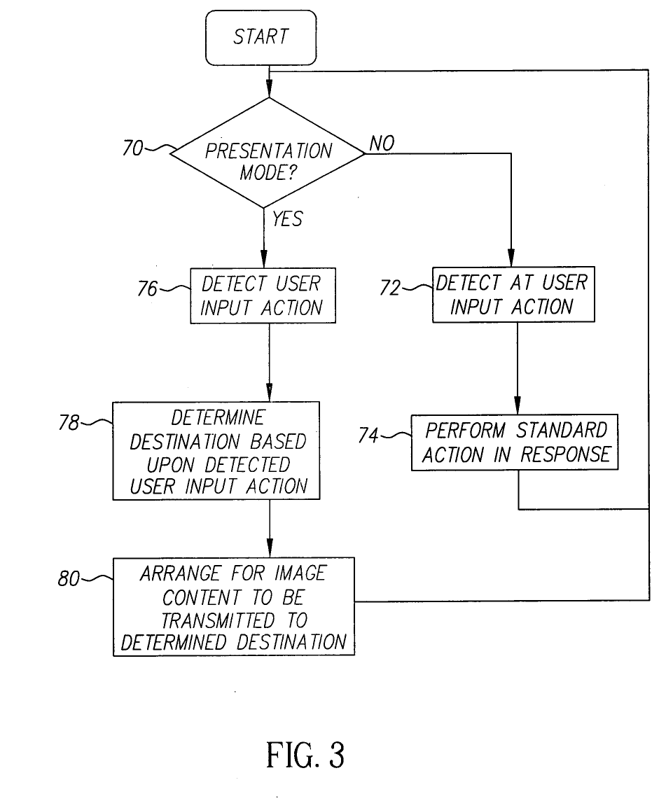

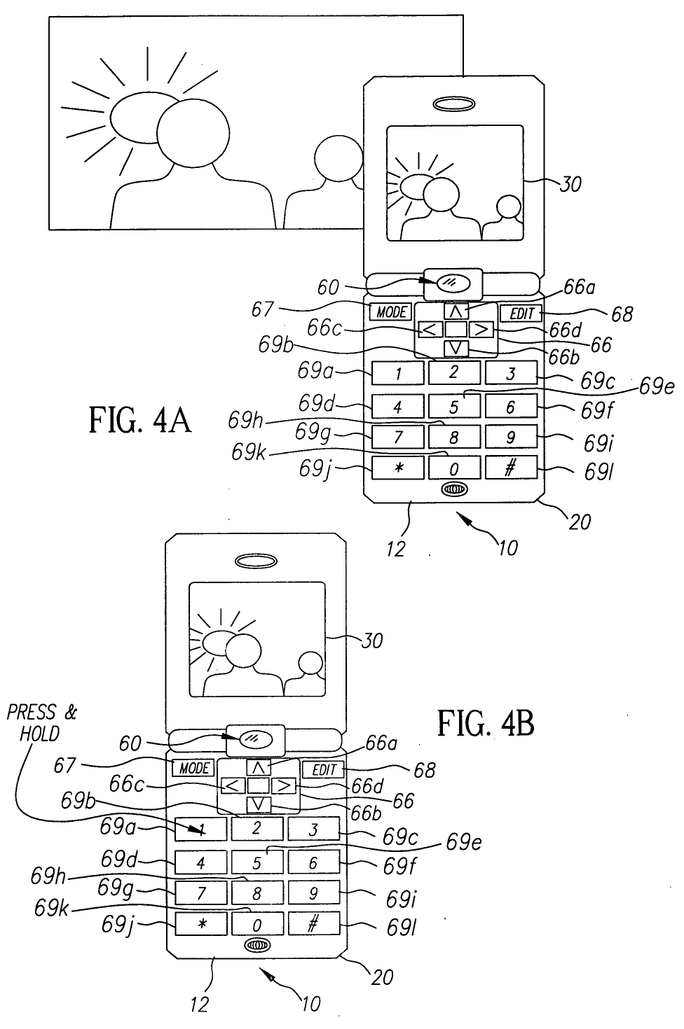

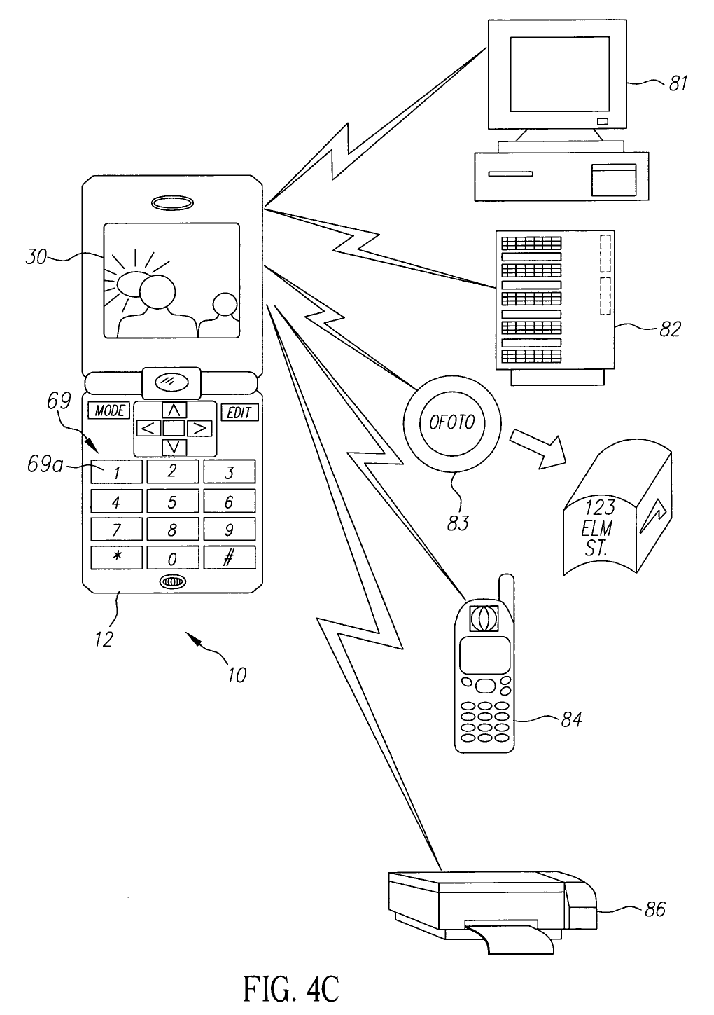

FIG. 3 shows a block flow diagram of a first embodiment of a method for sharing of image content using the image content sharing device 10 of the invention. FIGS. 4A-4C illustrates the process of sharing an image using the method of the invention. In the embodiment of FIGS. 3 and 4A-4C, image content sharing device 10 is operable in a variety of modes including a image content presentation mode where image content sharing device 10 presents digital image content stored therein on display 30.

When image content sharing device 10 is in any mode other than the image content presentation mode (step 70), controller 32 is adapted to receive user input signals from user input system 34 (step 72) and to take a standard action in response to the user input (step 76). However, as will be explained in greater detail below, when image content sharing device 10 is in an image content presentation mode (step 70) and detects a user input signal indicating that user input action has been taken (step 76), controller 32 executes a sharing operation. In accordance with the invention, the sharing operation comprises determining a destination for transmitting digital image content that is currently being presented on display 30 (step 78) and for arranging for such content to be transmitted to a user (step 80). It will be appreciated that this approach enables a user to arrange for image content to be shared with a selected user by making a single user input action. This approach also offers the advantage of not requiring that image content sharing device 10 incorporate designated user inputs to allow for such functionality and thus enables image content sharing device 10 to provide this functionality without unnecessarily increasing the size or complexity of image sharing device.

FIGS. 4A-4C illustrate one example embodiment of the method of FIG. 3 as applied to the digital camera/cellular phone12 embodiment of FIG. 2. As is shown in FIG. 4A, this method begins when controller 32 determines a mode of operation (step 70). When controller 32 determines that image content sharing device 10 is not in an image content presentation mode, depressing for example one key 69a causes controller 32 to determine that the user wishes to perform a standard action associated with that key such as entering a numeric one value and will interpret such a user input action in a standard manner (step 74). In a cellular phone style embodiment this can be interpreted by controller 32 as a signal to cause controller 32 to begin a cellular telephone dialing operation or to perform an unlock procedure to unlock the cellular telephone keypad 69.

Controller 32 can determine that it is to enter into an image presentation mode, when it detects any condition in which controller operate in any mode of operation wherein content is to be presented on display 30 or on any other display with which image content presentation device is associated (step 70). For example, controller 32 can enter an image content presentation mode when a user of image content sharing device 10 actuates mode select button 67 to select an image content presentation mode wherein digital image content is presented on display 30. Alternatively, where image content sharing device 10 comprises an image capture system 22, image content can be presented during capture, or during a verification process after capture. It will be appreciated that an image content presentation mode can be entered in other ways.

If during the image content presentation mode, controller 32 detects a user input signal from user input system 34 indicating that a user has made a user input action, such as where controller 32 detects a signal indicating that as illustrated in FIG. 4A, one key 69a has been actuated, controller 32 begins an image content sharing process (step 76). Controller 32 then uses the user input signal to determine a destination for the digital image content. In the embodiment of image content sharing system 10 shown in FIGS. 1-4C, user input system 34 is a button and key based system comprising, as described above, capture button 60, a directional keypad 66 having keys 66a-66d, mode select button 67, edit button 68 and numeric keypad 69 with numeric keys 69a-69l. Accordingly, in this embodiment controller 32 analyzes the user input signal to determine which of the keys has been pressed.

Controller 32 determines destination information for the currently presented image content based upon which key is pressed (step 76). There are two ways in which this can be done. In the embodiment of FIGS. 1 and 2 the destination information comprises a virtual or real address to which digital image content is to be sent based upon the detected user input action (step 78). Examples of such addresses include but are not limited to such as a virtual address, an instant mail address, an e-mail address, a file transfer protocol location, cellular phone number, a physical address or any other form of information that can be used to allow image content to be transmitted in an electronic form to a destination. In another aspect of the invention the destination can comprise a physical address, or any other information that can be used to at least in part help to identify a physical location to which a tangible medium of expression such as a compact disk, video tape, digital versatile disk, photo album, photographic print, digital tape, shirt, cup, banner, flag or any other form of output based upon such digital image content is to be sent. In such an embodiment, the digital image content is sent in electronic form to a photofinisher, such as OFOTO.COM, or a video-rendering agency who renders such an output and transmits it to the physical destination.

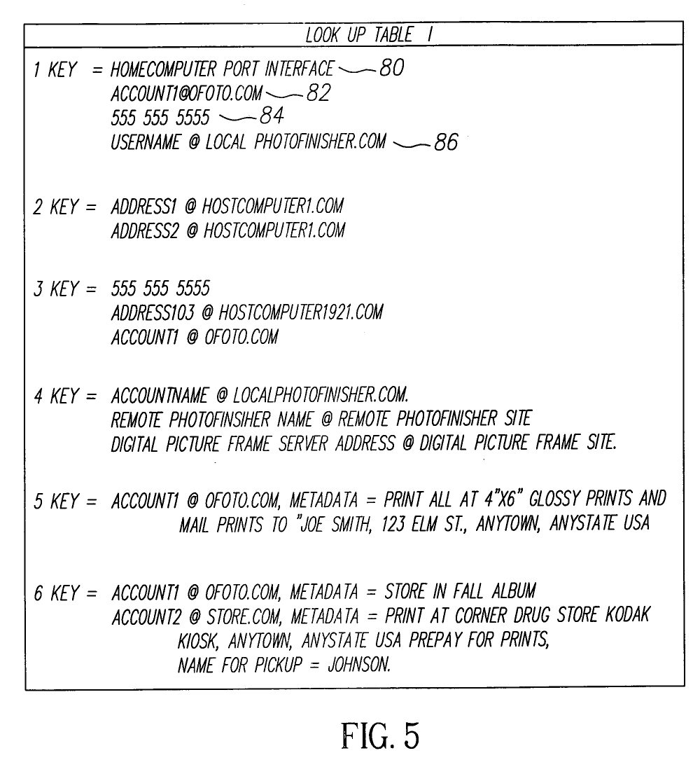

There are a variety of ways in which controller 32 can determine destination information based upon the detected user input action. In the embodiment of FIGS. 1 and 2, such a determination is made using a look-up-table (LUT) such as the LUT illustrated in FIG. 5 that associates one or more of the buttons of user interface 32 with destination information providing an address for a specific destination or combination of destinations and, optionally, other data that can be used to transmit the digital image content or a version of the digital image content to the destination. Such other data can include information that can be used by controller 32 and/or signal processor 26 to adapt the digital image content so that it is best formatted for use at the destination, such as by adapting the image resolution, image type, compression standards or any other properties of the digital image content so that the digital image content that is sent to the destination is usable by particular digital image using equipment at the destination, or data that identifies particular forms of output, an intended recipient, payment information or delivery information.

Such a look up table or other data structure can be created manually, by entering information that defines associations between particular user input actions and particular destinations or groups of destinations using keypad 69 or some other type of user input system 34. Alternatively, associations between particular destinations and particular user input actions can be established using a personal computer or other convenient input device. The personal computer or other convenient input device can then format the associations into a LUT or other data structure that provides such associations and transfer the associations to the image content sharing device.

The LUT or other data structure can also be automatically established and or supplemented by automatically building associations between specific user input actions and remote destinations that have shared digital image content with image content sharing device 10 or with other devices such as a personal computer to which image content sharing device 10 is commonly connected. For example, controller 32 and/or communication circuit 54 can be adapted to automatically extract destination information from communications that are used to send image content to image sharing device 10 and can build a LUT or other data structure that associates a user input action with such destinations. Such a system can be further adapted to organize the LUT based upon frequency of such data and/or the nature of such sharing. For example, destinations can be prioritized or otherwise organized so that the LUT or other data structure associates the most convenient forms of user input action with destinations that are more frequently used for image content sharing. In another example, destinations can be prioritized or otherwise organized so that the LUT or other data structure associates particular forms of user input action with particular destinations based upon the nature of image content exchanges between the image sharing device and the destinations.

Once a LUT or other data structure associating particular user input actions is defined, controller 32 will monitor the user input signal from user input system 34 to detect such user input actions when image content is presented. In the example embodiment illustrated in FIGS. 1-5, when controller 32 detects depression of, for example, one key 69a, controller 32 consults the LUT shown in FIG. 5 to determine one or more destinations from among a plurality of possible destinations listed in the LUT of FIG. 5. As illustrated in FIGS. 4C and 5, the selected destinations associated with the user action of pressing the one key 69a include computer 81, server 82, a photofinisher 83 who renders a tangible medium such as a photographic print and transmits the rendered print automatically to a designated physical address at a destination, a cellular phone 84 and a printer 86.

During the sharing process, controller 32 further arranges for the digital image content to be shared with each destination (step 80). In one embodiment of the invention this is done by controller 32 causing communication circuit 54 establish a wired or wireless communication link with each destination and to transfer the digital image content to each destination directly or by way of a server such as a telecommunication provider, an internet server, a wired or wireless communication server, a network of retail kiosks or other commercial terminals providing a communication path between an image content sharing device 10 and a destination, by way of a third party provider.

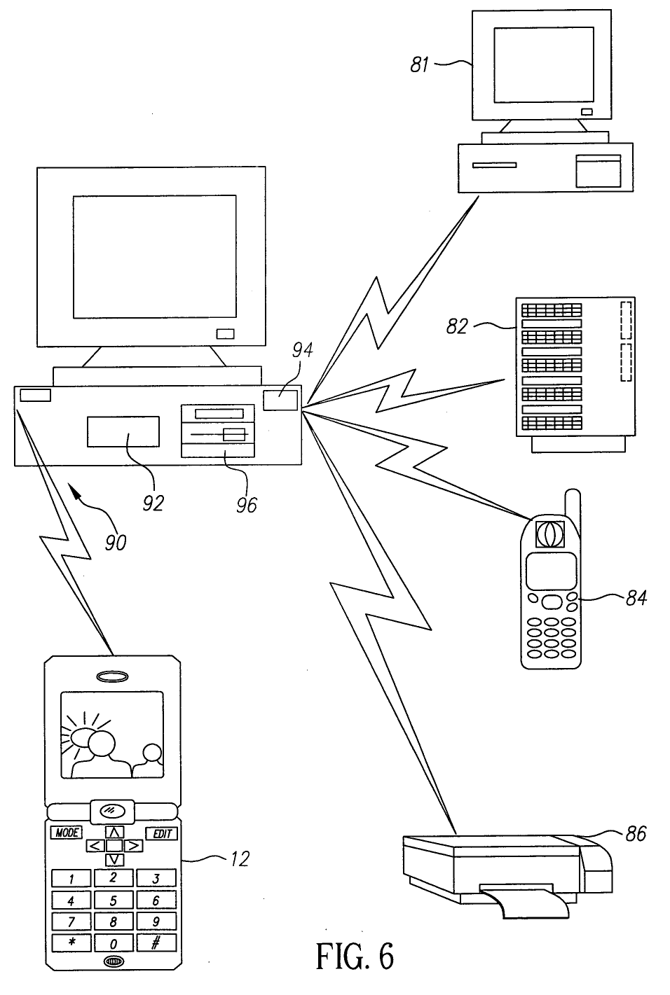

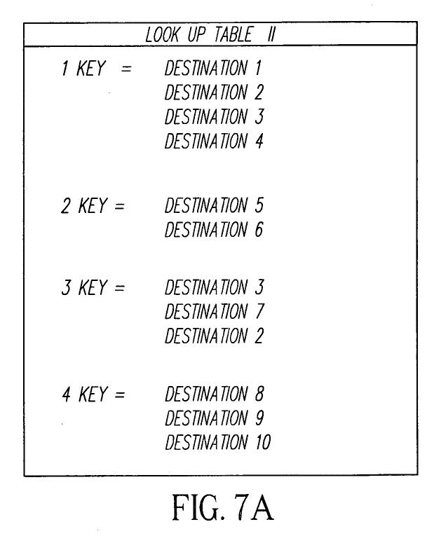

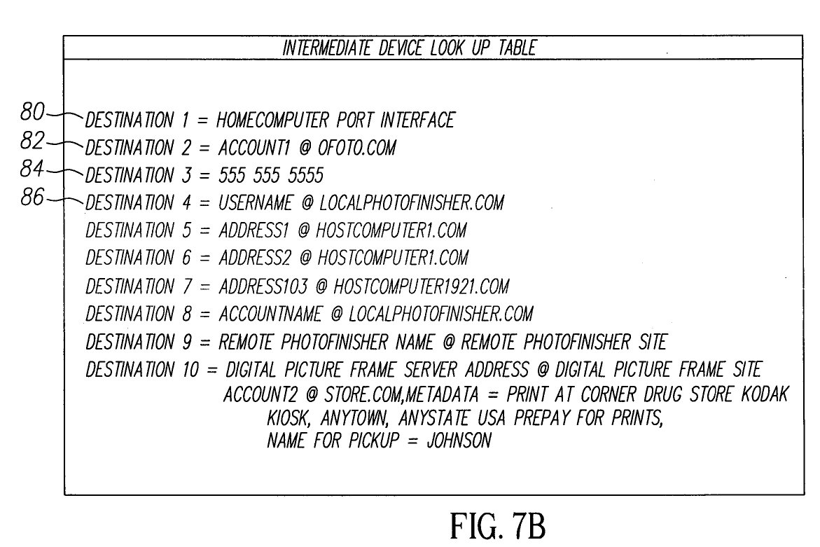

In another example embodiment, illustrated in FIGS. 6, 7A and 7B, controller 32 performs the step of arranging for the digital image content to be transmitted to one or more destination by arranging for image content to be uploaded to an intermediate device 90 with metadata or other instructions that will cause intermediate device 90 to initiate or execute the process of transferring the digital image content to the selected destination or destinations or cause some form of tangible medium to be rendered and shipped to a physical destination. In one embodiment, the intermediate device 90 can comprise, for example, a personal computer to which image content sharing device 10 is docked by way of a cable and/or a docking station such as the Kodak EASYSHARE digital camera docking station sold by the Eastman Kodak Company, Rochester, N.Y., U.S.A., or a wireless connection.

In embodiments where an intermediate device 90 is used to transfer digital image content to a remote server, controller 32 can be adapted to provide information other than physical or virtual address information, phone numbers or the like, in order to cause intermediate device 90 to transfer the digital image content to the destination. In one example embodiment of this type, where an image content sharing device 10 such as a digital camera is provided that is adapted to upload images when docked in a docking station associated with a personal computer, controller 32 can be adapted to arrange for the digital image content to be transferred to a destination by causing digital image content to be associated with destination metadata that is determined based upon the detected user input action. FIG. 7A shows one example of an embodiment of a LUT with various user inputs stored in association with one example of such destination data.

In this embodiment, intermediate device 90 has an intermediate device controller 92, and intermediate device communication circuit 94 and intermediate device controller memory 96 with an intermediate look up table that associates the destination data with addresses or other information that can be used to help transmit the digital image content to a preferred destination. Accordingly, in such an embodiment, controller 32 need only provide digital image data and data designating a destination from which device controller 92 can determine an actual address or other information, and can cause intermediate device communication circuit 94 to transmit the digital image content to addresses that are determined in accordance with the destination data provided by controller 32. Such destination information can comprise any form of information that can be provided to intermediate controller 32 to indicate destinations that were selected by a user of image content sharing device 10 during the image content presentation mode. As shown in FIG. 7B, intermediate device 90 can have an intermediate device LUT or some other convenient data structure that can be used to by intermediate device controller 92 to determine virtual or real addresses, phone numbers or other information that can be used to transmit the digital image content based upon the destination data.

The destination data can comprise for example data that characterizes any user input signal received by controller 32 when in an image content review mode or data that characterizes only selected data from any user input signal received by controller 32. Such destination data can also comprise, for example, a code representing a portion of the intermediate device look up table, an image, graphic symbol or character representing such a person. Such an approach can be useful where, for example, a user does not want to store actual address information in a portable image content sharing device 10 that could be lost or stolen.

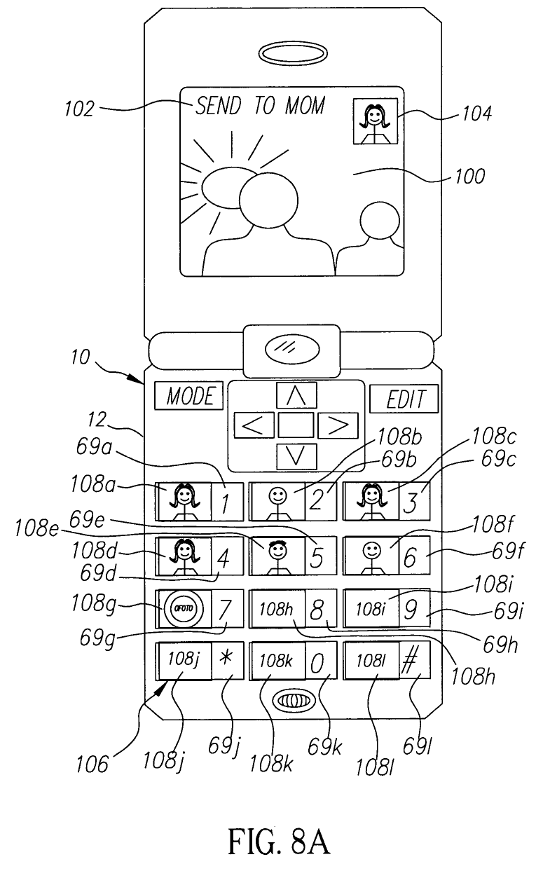

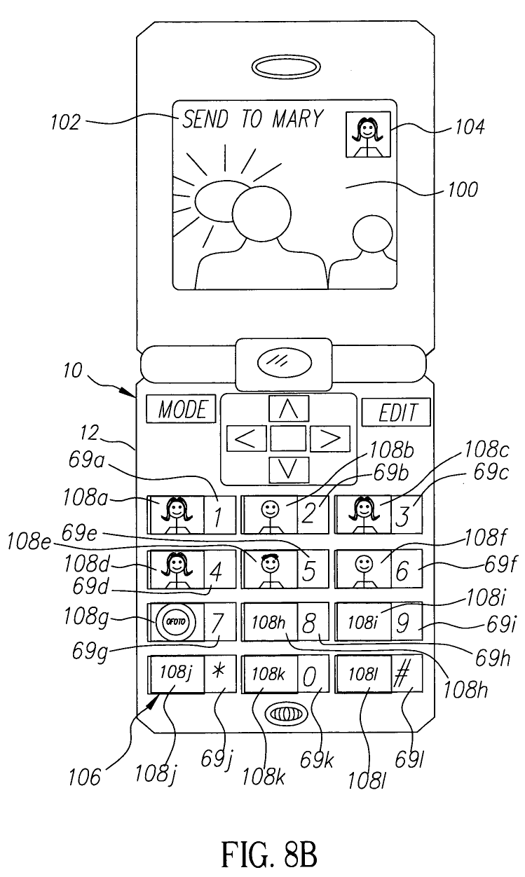

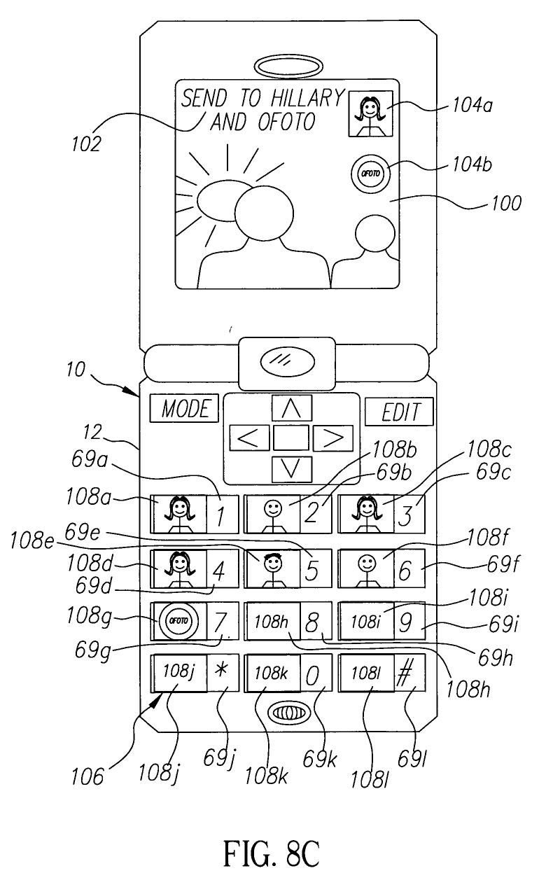

It may be useful for image content sharing device 10 to provide a user with a graphic indication to confirm that the image will be sent to the designated recipient. In the embodiment of FIGS. 8A, 8B and 8C one example is illustrated wherein when the user makes a user input action of pressing the four key 69d during an image content presentation mode shown in FIG. 8A. As is shown in FIG. 8A, when this occurs a text message 102 and an image 104 are presented indicating that the presented image content 100 will be sent to Mom. As shown in FIG. 8B, when display 30 presents image content 100 and when a user presses the two button 69b, controller 32 determines that an image is to be sent to Mary and text 102 and an image 104 representing the intended recipient are presented on display 30. In this case, an image of Mary is presented on display 30 along with optional text 102 that indicates that such a transmission will occur. As is discussed above a user can make one or more user input actions during presentation of image content 100 to designate that presented image content is to be transmitted to more than one destination. As shown in FIG. 8C, where this is done controller 32 can cause a text 102 and/or multiple images 104a and 104b reflecting such multiple destinations to be presented on display 30. There are a number of possible variations of such an approach. Audio and/or tactile signals can also be used for providing such feedback.

As is also shown in the example of FIG. 8A, user input system 34 has keys 69a-69l with destination indicators 106 associated therewith. Such destination indicators 106 provide human perceptible outputs associated with particular ones of the user input system indicating a particular user input action will cause the presented image content to be transmitted to a particular destination. In the example illustrated, destination indicators 106 comprise image displays 108a-108l that are incorporated into keys 69a-69l respectively. In this embodiment, image displays 108a-108g are used to present images representing the destinations to which a user input action will cause content to be sent when keys 69a-69g are pressed, while image displays 108h-108l have no images presented therein as no destination is assigned to the user actions of depressing keys 69h-69i.

It will be appreciated that, destination indicators 106 can be modified to generate a distinctly different output after selection than before, such as by changing the appearance of an image presented on image display 108a when, for example, key 69a is pressed. This can be used to provide graphic indication of the destinations to which the presented image content is to be presented as discussed above.

In certain alternate embodiments, a portion of a display 30 can be used to provide destination indicators 106, or, alternatively, destination indicators 106 can be provided on display 30 as an overlay while image content is also presented on display 30. In still other alternate embodiments, destination indicators 106 can provide other forms of signaling such as audio and tactile signals to indicate to a user that a particular user input action will cause presented image content to be transmitted to a particular destination.

As noted above, user input system 34 can be provided that is adapted to sense audio signals, such as by monitoring an audio type sensor 36 and adapting user input signals to incorporate sensed audio data. Where this is done the user input signal can be representative of such audio signals and controller 32 can be adapted to, alone, or in combination with signal processor 26 or in combination with other known circuits and systems interpret the audio signals when controller 32 is in an image content presentation mode and to determine when the audio signals indicate that an image is to be sent to a particular destination. For example, in one embodiment, the command “send to mike” can cause controller 32 to arrange for the digital image content to be transmitted to a destination associated with “Mike”. In another example embodiment, the command “press key 1” or “quick send key 1” can cause controller 32 to send digital image content to a destination or group of destinations associated with the number 1 key 69a on for example, key pad 69 of the embodiment of FIG. 1.

Such audio commands can be interpreted using conventional voice recognition technology and algorithms to convert audio signals into known commands or data based upon such signals where controller 32 is adapted for such a purpose. Alternatively, a user can preprogram image capture device 10 with certain patterns of audio signals comprising spoken words, which can be stored in a memory such as memory 40. In this latter alternative, when controller 32 is operated in an image content presentation mode, controller 32 is adapted to monitor audio signals proximate to the digital image content sharing device 10 for audible signals that conform to such prerecorded patterns. Where such signals are sensed, controller 32 can be adapted to execute a response to such a command.

It will be appreciated that even during an image content presentation mode, it is not necessary that each transducer or other device used in user input 34 be dedicated to the sharing function. Instead, it will often be the case that selected ones of the user input transducers or other devices will not be used for such a purpose but will provide a consistent functionality across many modes of operation. For example, in the embodiment of FIGS. 1 and 2, capture button 60, mode select button 67, and edit button 68 may always operate to enable a user to cause controller 32 to cause image sharing device 10 to perform desired operations such as digital image content capture, mode selection, or digital image capture, editing and the like.

Image content sharing devices 10 that capture video type digital image content in real time and present an evaluation video stream of the video type digital image content in real time are well known. This too is one example of an image presentation mode. In one embodiment of the invention, controller 32 can be adapted to monitor or detect user input signals and to determine a destination to which the currently video stream is to be sent. This enables rapid sharing of video image content in real time with a minimum amount of user involvement in making arrangements for sharing the images, particularly where making such arrangements could interrupt the capture of the digital image content or where the user of the image content sharing device cannot risk being distracted by the task of making such arrangements.

In the embodiments above, image content sharing device 10 has been generally illustrated in the form of digital camera/cellular telephone 12. However, image content sharing device 10 can comprise any form of device meeting the limitations of the claims, including but not limited to conventional digital cameras, personal computers, personal digital assistants, digital picture frames, digital photo albums, and the like.

The invention has been described in detail with particular reference to certain preferred embodiments thereof, but it will be understood that variations and modifications can be effected within the spirit and scope of the invention.

### PARTS LIST

8 scene
10 image content sharing device
12 digital camera
20 body
22 scene image capture system
23 scene lens system
24 scene image sensor
25 lens driver
26 signal processor
27 range finder
28 display driver
30 display
32 controller
34 user input system
36 sensors
37 source of artificial illumination
38 viewfinder system
40 memory
46 memory card slot
48 removable memory
50 memory interface
52 remote memory system
54 communication circuit
60 capture button
66 directional keypad
66a up arrow key
66b down arrow key
66c left arrow key
66d right arrow key
67 mode select button
68 edit button
69 keypad
69a one key
69b two key
69c three key
69d four key
69e five key
69f six key
69g seven key
69h eight key
69i nine key
69j star key
69k zero key
69l pound key
70 determine mode step
72 detect user input action step
74 perform standard action step
76 detect user input action
78 determine destination step
80 arrange for image content to be transmitted to determined destination step
81 computer
82 server
83 photofinisher
84 cellular phone
86 printer
90 intermediate device
92 intermediate device controller
94 intermediate device communication circuit
96 intermediate device controller memory.
100 image content
102 text
104, 104a, 104b image
106 destination indicator
108a-108l image displays

1. An image content sharing device comprising:
a display;
a memory;
a user input capable of receiving more than one user input action and of providing a user input signal indicative of each of the more than one user input actions; and
a controller operable in an image content presentation mode, wherein the controller causes image content to be presented on the display and at least one other mode; with the controller being adapted so that when the controller is in the image content presentation mode and detects a user input signal, the controller determines at least one destination, from among more than one possible destination, based upon the user input signal detected and arranges for the presented image content to be automatically transmitted to the at least one destination, with the controller further being operable in at least one other mode, so that when the controller is in the at least one other mode and the controller detects the same user input signal, the controller responds thereto in a manner that is different from the manner in which the controller responds to user input signal when the controller is in the image content presentation mode.

2. The image content sharing device of claim 1, further comprising a communication circuit that is adapted to provide a communication link between the image content sharing device and another device and wherein the controller is adapted to determine destination data that can be used by the communication circuit to establish a communication link with the remote device so that the digital image content can be sent to the destination.

3. The image content sharing device of claim 1, wherein said memory has address information stored therein that the controller can use to determine a destination based upon a detected user input signal.

4. The image content sharing device of claim 1, wherein said memory has a look up table stored therein that associates each of the more than one destination with a different user input action.

5. The image content sharing device of claim 1, wherein said controller is adapted to cause a communication link to be established with each destination for the transfer of image content to each destination.

6. The digital image content sharing device of claim 1, wherein the image content sharing device is adapted to arrange for the selected image content to be automatically transmitted to the destination by associating the selected image content with destination data that identifies the destination in a way that allows a remote image content sharing device to identify destinations for the digital image content and to cause the digital image content to be transmitted to the destination without providing all of the information necessary to transmit the data to the destination.

7. The digital image content sharing device of claim 6, wherein the destination data includes at least one of audio data, data based upon audio signals, digital data, graphics, text, and images that can be used by the intermediate device to determine sufficient information to enable the intermediate device to transmit the digital image content to the destination.

8. The digital image content sharing device of claim 7, wherein the controller is adapted to cause at least one of an audio, tactile, graphic, image, or textual indication to be generated that indicates that presented digital image content is to be transmitted to the determined at least one destination.

9. The digital image content sharing device of claim 1, wherein the user input system is adapted to receive signals from an audio sensor and to provide a user input signal to controller from which the controller can determine a destination or destination data.

10. An image content sharing device comprising:
a display;
a user input circuit having a plurality of inputs adapted to provide differentiable input signals with each differentiable input signal being generated in response to a differentiable user input action; and
a controller operable to receive the set of differentiable input signals and to use the sensed input signals to perform a set of operations, including causing image content to be presented on the display;
said controller further being operable during presentation of the image content, to sense at least a portion of the same set of differentiable input signals and to arrange for the image content to be transmitted to a particular destination, selected from among more than one possible destination, based upon the sensed differentiable input signals.

11. The image content sharing device of claim 10, wherein said user input system and controller are adapted so that a user can utilize the user input system to define associations between particular user input actions and destinations so that the controller can use said defined associations to arrange for the image content to be transmitted to such destinations.

12. The image content sharing device of claim 10, further comprising a communication circuit, said communication circuit adapted to receive communications having image content data from destinations, to extract destination address information so that the destination address information can be used to transmit image content to such destinations and so that such a destination can be automatically associated with a user input action.

13. The image content sharing device of claim 12, wherein the user input system wherein automatic associations between the user input actions and particular destinations are made based upon the frequency or nature of communications between the destination and the image content sharing device.

14. The image content sharing device of claim 10, wherein the user input system has destination indicators associated with human perceptible outputs indicating that at least one user input action will cause presented image content to be transmitted to a particular destination.

15. The image content sharing device of claim 10, wherein the controller is further adapted to provide at least one of human perceptible visual or audio signal indicating that a user has designated that particular image content is to be transmitted to a particular one of the destinations in response to a user input action.

16. A method for operating an image content sharing device comprising the steps of:
presenting image content;
detecting at least one user input action during presentation of the image content;
determining a destination from among more than one possible destination for sharing the presented image content based upon the user input action detected during the display of the digital image content; and
arranging for the presented image content to be transmitted to the determined destination without further user input action.

17. The method of claim 16, wherein the step of arranging for the digital image content to be transmitted to the determined destination comprises at least one of the steps of transmitting the image content using a telecommunication system, transmitting the image content using a computer network, transmitting the image content to an intermediate device causing the intermediate device to transmit the image content in electronic form to a destination, and transmitting the image content to an intermediate device causing the intermediate device to render a tangible output based upon the image content to be rendered for transmission to a physical destination.

18. The method of claim 16, wherein the step of determining a destination for the image content comprises transmitting the image content and destination data to a remote device with said destination data providing information from which the remote device can determine a destination for the image content.

19. The method of claim 16, further comprising the steps of receiving a communication from a destination and automatically associating a user input action with that destination.

20. The method of claim 16, further comprising the step of providing a visual, audio or tactile signal at least when image content is being presented, such visual, audio, or tactile signals providing proximate particular portions of a user input system that are adapted to sense user input actions said visual signal providing a user detectable providing an indication of the destination to which the presented image content will be sent if the user takes the user input action.
